(19) United States
(12) Patent Application Publication
(10) Pub. No.: US 2026/0320287 A1
(43) Pub. Date: Oct. 15, 2026

(54) AUTOMATIC INFORMATION COLLECTION METHOD, APPARATUS, ELECTRONIC DEVICE, MEDIUM, AND PRODUCT

(71) Applicants: BYTEDANCE TECHNOLOGY LTD., Grand Cayman (KY); BEIJING ZITIAO NETWORK TECHNOLOGY CO., LTD., Beijing (CN)

(72) Inventors: Junyuan QI, Singapore (SG); Bowen SHEN, Beijing (CN); Jingkang LIU, Beijing (CN); Ruolei JIANG, Beijing (CN)

(21) Appl. No.: 19/546,204

(22) Filed: Feb. 20, 2026

(30) Foreign Application Priority Data
Apr. 11, 2025 (CN) 202510453883.X

(51) Int. Cl. G06F 40/166; G06F 3/0483; G06F 3/0484; G06T 7/70; G06V 20/62

(52) U.S. Cl. CPC G06F 40/166; G06F 3/0483; G06F 3/0484; G06T 7/70; G06V 20/62

(57) ABSTRACT

The present disclosure relates to an automatic collection method of information and apparatus, an electronic device, a medium, and a product, and belongs to the field of computer technologies. The automatic collection method of information includes: determining, according to a task sent from a user to an agent, a platform corresponding to the task and a task requirement; performing operations according to an image of an interface and the task requirement, the interface corresponding to the platform, and the operations including an interaction operation with the platform and an operation of obtaining target information from the platform; writing the target information into a document; and displaying the document to the user, the document being provided by the agent.

### CROSS-REFERENCE TO RELATED APPLICATIONS

The present disclosure is based on and claims the priority of Chinese Patent Application No. 202510453883.X, filed on Apr. 11, 2025, the disclosure of which is hereby incorporated into this disclosure by reference in its entirety.

### TECHNICAL FIELD

The present disclosure relates to the field of computer technologies, and in particular, to an automatic information collection method and apparatus, an electronic device, a medium, and a product.

### BACKGROUND

Some users have a need for information collection. For example, a user needs to learn information about new products in a certain field at one time or periodically, and then summarize the collected information. To perform this operation, the user needs to manually visit many platforms or many pages of a platform to determine which information is available one by one. If the information is available, the user manually copies the information and pastes the information into a document.

### SUMMARY

According to some embodiments of the present disclosure, an automatic information collection method is provided. The method includes: determining, according to a task sent from a user to an agent, a platform corresponding to the task and a task requirement; performing operations according to an image of an interface and the task requirement, the interface corresponding to the platform, and the operations including an interaction operation with the platform and an operation of obtaining target information from the platform; writing the target information into a document; and displaying the document to the user, the document being provided by the agent.

According to some other embodiments of the present disclosure, an automatic information collection apparatus is provided. The apparatus includes: a determination module configured to determine, according to a task sent from a user to an agent, a platform corresponding to the task and a task requirement; an execution module configured to perform operations according to an image of an interface and the task requirement, the interface corresponding to the platform, and the operations including an interaction operation with the platform and an operation of obtaining target information from the platform; a writing module configured to write the target information into a document; and an interaction module configured to display the document to the user, the document being provided by the agent.

According to some embodiments of the present disclosure, an electronic device is provided. The electronic device includes: a memory; and a processor coupled to the memory, where the processor is configured to perform the automatic information collection method according to any one of the embodiments of the present disclosure based on instructions stored in the memory.

According to some embodiments of the present disclosure, a non-transitory computer-readable storage medium is provided. The computer-readable storage medium stores a computer program that, when executed by a processor, causes the processor to perform the automatic information collection method according to any one of the embodiments of the present disclosure.

According to some embodiments of the present disclosure, a non-transitory computer program product is provided. The computer program product, when running on a computer, causes the computer to implement the automatic information collection method according to any one of the embodiments of the present disclosure.

Other features, aspects, and advantages of the present disclosure become apparent with reference to the following detailed description of exemplary embodiments of the present disclosure.

### BRIEF DESCRIPTION OF THE DRAWINGS

Embodiments of the present disclosure are described below with reference to the drawings. It should be understood that the drawings in the following description relate to some embodiments of the present disclosure, but do not limit the present disclosure. In the drawings:

FIG. 1 is a schematic flowchart of an automatic information collection method according to some embodiments of the present disclosure;

FIG. 2 is a schematic flowchart of an information writing method according to some embodiments of the present disclosure;

FIG. 3 is a schematic flowchart of an information writing method according to some other embodiments of the present disclosure;

FIG. 4 is a schematic flowchart of an operation execution method according to some embodiments of the present disclosure;

FIG. 5 is a schematic diagram of an interaction interface of an agent;

FIG. 6 is another schematic diagram of an interaction interface of an agent;

FIG. 7 is a schematic diagram of a structure of an automatic information collection apparatus according to some embodiments of the present disclosure;

FIG. 8 is a block diagram of an electronic device according to some embodiments of the present disclosure; and

FIG. 9 is a block diagram of an electronic device according to some other embodiments of the present disclosure.

### DETAILED DESCRIPTION OF EMBODIMENTS

The technical solutions in the embodiments of the present disclosure are clearly and completely described below with reference to the drawings in the embodiments of the present disclosure. It should be understood that the present disclosure may be implemented in various forms, and should not be construed as limited to the embodiments set forth herein.

It should be understood that steps described in method implementations of the present disclosure may be performed in different orders and/or in parallel. Furthermore, the method implementations may include additional steps and/or omit the steps shown. The scope of the present disclosure is not limited in this regard. Unless otherwise specified, relative arrangements of the steps set forth in these embodiments should be construed as merely exemplary and do not limit the scope of the present disclosure.

The term "include/comprise" and its variants used in the present disclosure mean open terms that include/comprise at least the following elements/features, but do not exclude other elements/features, that is, "include/comprise but not limited to". The term "based on" means "at least partially based on".

It should be noted that concepts such as "first" and "second" mentioned in the present disclosure are merely used to distinguish between different apparatuses, modules, or units, and are not used to limit an order or interdependence of functions performed by these apparatuses, modules, or units. Unless otherwise specified, concepts such as "first" and "second" are not intended to imply that the objects so described must be in a given order in terms of time, space, ranking, or in any other manner.

It should be noted that modifications of "one" and "a plurality of" mentioned in the present disclosure are illustrative and non-limiting, and those skilled in the art should understand that unless clearly indicated in the context, they should be construed as "one or more".

Names of messages or information exchanged between a plurality of apparatuses in the implementations of the present disclosure are used for illustrative purposes only, and are not used to limit the scope of the messages or information.

User information (including but not limited to user device information, user personal information, etc.) and data (including but not limited to data for analysis, stored data, displayed data, etc.) involved in the present disclosure are information and data authorized by users or fully authorized by all parties, and the collection, use, and processing of the relevant data need to comply with relevant laws, regulations, and standards of relevant countries and regions, and corresponding operation entry is provided for users to choose to authorize or to refuse.

The embodiments of the present disclosure are described in detail below with reference to the drawings, but the present disclosure is not limited to these specific embodiments. The following specific embodiments may be combined with each other, and the same or similar concepts or processes may not be described in detail in some embodiments. Furthermore, in one or more embodiments, specific features, structures, or characteristics may be combined in any suitable manner apparent to those of ordinary skill in the art from the present disclosure.

It should be understood that the present disclosure does not limit how to obtain the image to be applied/processed. In some embodiments of the present disclosure, the image may be obtained from a storage apparatus, such as an internal memory or an external storage apparatus. In some other embodiments of the present disclosure, a photographing component may be mobilized to take a picture. It should be noted that the obtained image may be a captured image or a frame of image in a captured video, which is not particularly limited thereto.

The manner in which the user manually collects information requires a large number of operations of the user, which is cumbersome, especially when the user needs to screen and discriminate information from a large number of pages of the information source. If the operations of the user are replaced with an automated manner, the efficiency of information collection of the user will be greatly improved.

In related technologies, a crawler technology may be used to collect information. The crawler technology parses the HTML (Hyper Text Markup Language) structure of a web page to extract content in a specific label or content matching a specified keyword. However, the user needs to have a very good understanding of the structure of the website that the user wants to visit, and also needs to write specific code. Therefore, it is difficult for a user who knows little about computer technologies to quickly and automatically collect information in this way. Moreover, different websites or pages use different webpage structures, and when information is obtained from different information sources, different crawler codes need to be written separately, so the cost of information acquisition is also relatively high.

The present disclosure provides a solution of information automatically collecting by using an agent. The agent understands a task sent from a user to determine a task requirement, and automatically performs an interaction operation and an information acquisition operation on a platform in combination with an image of the platform where an information source is located. In this way, the use threshold of the user may be reduced, and more users may be assisted to automatically collect information.

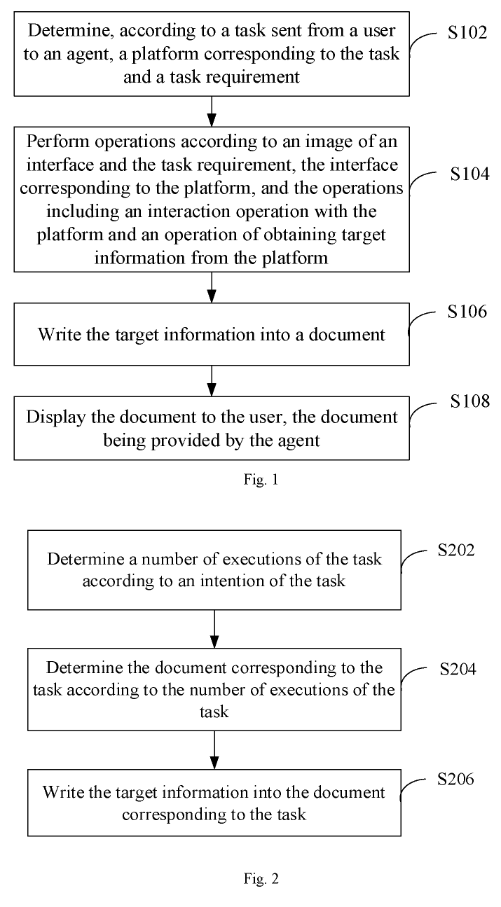

FIG. 1 is a schematic flowchart of an automatic information collection method according to some embodiments of the present disclosure. As shown in FIG. 1, the automatic information collection method in this embodiment includes steps S102 to S108.

In step S102, a platform corresponding to a task and a task requirement are determined according to the task sent from a user to an agent.

The user may publish the task through an interaction interface with the agent. The interaction interface may be, for example, a text input window, an image input control, a voice input control, etc., to facilitate the user to describe the task in any manner of text, image, voice, etc.

The agent is an intelligent object that may interact with the user through the electronic device. The agent may send a reply corresponding to an instruction of the user to the user according to the instruction. The agent may be implemented based on a machine learning model, for example, a large language model (abbreviated as LLM) or a foundation model. The machine learning model may be a generative model, and the generative model is used to output target content based on input information. The information input to the generative model includes a processing basis of the generative model in a generation process, for example, information to be referred to for performing the generation process, a requirement for the output target content, etc. The generative model includes, for example, a model that performs generation based on text or a model that performs generation based on an image, and the output of the generative model may include text, an image, or a combination thereof. Certainly, the input or output of the generative model may also be data in other modalities, such as audio, video, or a combination of multiple types of data. The generative model may be a single-modal model, such as a model that generates text based on text (abbreviated as "text-to-text model"), and a model that generates an image based on an image (abbreviated as "image-to-image model"). Alternatively, the generative model may be a cross-modal model, that is, a model whose input and output belong to different modalities, such as a model that generates an image based on text (abbreviated as "text-to-image model"). Still alternatively, the input of the generative model may include multiple modalities, and the output may also include multiple modalities. The agent may also have a control module (such as control logic) to control the agent to interact with the model. For example, the control module controls to send information obtained by the agent to the model, to the user, or for further processing.

The process of determining the platform corresponding to the task and the task requirement may be implemented using a model. For example, the task sent from the user, or a result of the conversion of the task (such as a result of voice-to-text), and indication information are input to the model, where the indication information is used to indicate the model to determine the platform corresponding to the task and the task requirement. The model may determine the platform and the task requirement using its semantic understanding capability and a knowledge base, and output them to the user. An output result may be fed back to the user through the interaction interface between the agent and the user, for example, displayed on the interaction interface between the user and the agent, or output through voice of the agent, so that the user may confirm whether the understanding of the task by the agent is correct. Certainly, the understanding result may not be fed back to the user, and the subsequent process may be directly performed.

The platform corresponding to the task includes the information that the user wants to collect, and the platform may be a website, software, etc. The platform may include text, images, controls, etc., and the agent may copy the information on the platform or perform an interaction operation through the control.

The task requirement is used to describe the information that the user expects to obtain, and may include a type, a theme, timeliness, a number, an output format of the collected information, etc.

After the platform and the task requirement are determined, the interface of the platform may be opened in the foreground or background of the user device to facilitate obtaining the image of the interface of the platform.

In step S104, operations are performed according to the image of the interface and the task requirement, the interface corresponding to the platform, and the operations including an interaction operation with the platform and an operation of obtaining target information from the platform.

Step S104 is automatically performed by the agent, for example, by the control module of the agent. Moreover, step S104 may be cyclically performed multiple times. In a specific interface, the agent may only perform the interaction operation, may only obtain the target information, or may perform both the interaction operation and the operation of obtaining the target information. The agent may also trigger the display of other interfaces through the interaction operation, and continue to perform one or more of these operations.

The image of the interface may be obtained through an automatic screenshot or screen recording function. A trigger condition may be set for automatic obtaining of the image of the interface, so as to automatically obtain images of a plurality of interfaces. For example, the image is periodically obtained to simplify the processing logic. For another example, the image is obtained in response to each interaction operation, so as to promptly obtain the image of the interface that is changed due to the interaction operation. For still another example, the image is obtained in response to each interaction operation, and the image is also obtained in the case that the execution of a previous interaction operation has exceeded a time threshold. In this way, a change occurring in the interface may be more promptly captured.

The interaction operation with the platform includes, for example, an operation of triggering a control, for example, triggering the control to open a pop-up window, execute a function, or open a new page. The interaction operation also includes, for example, a displacement operation of the interface, for example, scrolling the interface up, down, left or right to display more content in the interface, or sliding the interface up, down, left or right to trigger the display of a new page.

After each image is obtained, image processing may be performed on the image to determine the information included in the image. Then, the model may be used to further process a result of the image processing and the task requirement, so as to obtain the target information to be extracted or the interaction operation to be performed next returned by the model.

When the interaction operation or the information acquisition operation is automatically performed with the assistance of the agent, an operation position may be determined based on the image, and an interface provided by an operating environment (such as a browser) may be used to control a simulated input device such as a simulated mouse or a simulated keyboard to perform a simulated operation on the platform. Therefore, the agent may automatically perform the operation instead of the user.

In step S106, the target information is written into a document.

Step S106 is automatically performed by the agent, for example, by the control module of the agent.

The document may be a document specified by the user, or may be a document determined by the agent according to the task requirement. The document may be newly created for this task, or may have content before the information corresponding to this task is written.

The document may be of multiple types. The document may be a file in a specific document software format, or may be an editable object (such as a blog) in a specific application platform, which is not limited in the present disclosure.

In step S108, the document to the user is displayed, the document being provided by the agent.

The agent may provide a quick access entry for the document to the user, or may directly display content of the document through a preview interface associated with the agent. Based on a requirement, the user may perform operations such as further editing, storing the document, forwarding the document, or publishing the document on a website or an application based on the result automatically collected by the agent.

In the present disclosure, the agent processes the image of the interface of the platform corresponding to the task to determine a next operation of the agent, so that the target information may be identified and obtained from the platform and written into the document. Therefore, the user may obtain the information document automatically collected by the agent by sending the task to the agent, which reduces the threshold for automatic information collection and improves the efficiency of information collection.

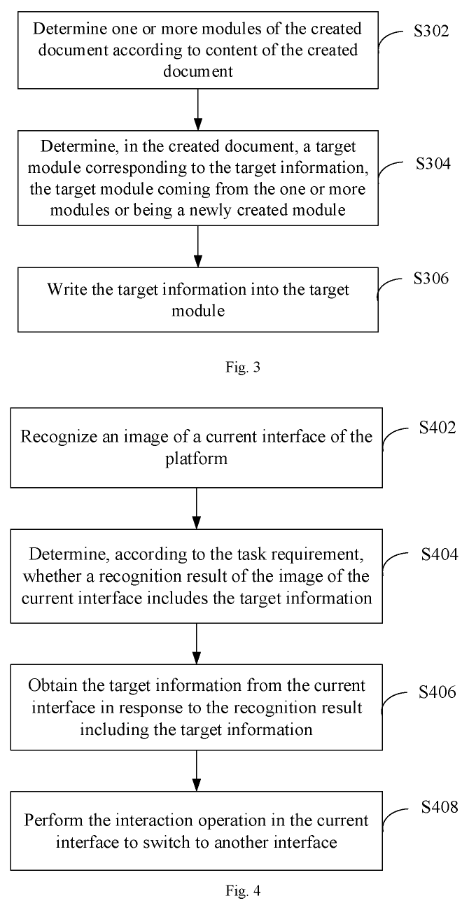

The preceding solution may efficiently assist the user in creating or improving the document. For example, the agent may automatically decide which document or which part of the document the collected information is written into. A document writing solution is exemplarily described below with reference to FIG. 2 and FIG. 3.

FIG. 2 is a schematic flowchart of an information writing method according to some embodiments of the present disclosure. As shown in FIG. 2, the information writing method in this embodiment includes steps S202 to S206.

In step S202, a number of executions of the task is determined according to an intention of the task.

The task may clearly indicate the number of executions of the task, for example, "help me collect AI-related products on website A, collect once today and collect once tomorrow".

If the task does not clearly indicate the number of executions, a machine learning model may be used to process the task or the task requirement to determine the intention of the task. If the intention of the task represents that the task is a task that needs to be periodically executed, the task needs to be executed multiple times. In addition, whether the task needs to be executed multiple times may also be determined based on the intention of the task and an update frequency of the information on the platform. For example, "help me collect abstracts and authors of articles in the AI field published on website B in the next 7 days". Through intention analysis and in combination with the update frequency of website B being once a day, it may be determined that the task needs to be executed 7 times. If the update frequency of the website is uncertain, but it is learned from the intention that the task is a continuous task within 7 days, it may also be determined that the task needs to be executed multiple times.

In step S204, a document corresponding to the task is determined according to the number of executions of the task.

For example, if the task only needs to be executed once, the document corresponding to the task is a newly created document.

For another example, if the task needs to be executed multiple times, the document corresponding to the task may be further determined in combination with a current execution sequence number of the task.

In some embodiments, the document is a created document, and determining the document corresponding to the task according to the number of executions of the task includes: determining a created document associated with the task as the document corresponding to the task in response to the task having been executed at least once; and determining a newly created document as the document corresponding to the task in response to the task being executed for the first time.

For example, if the task is executed multiple times, a correspondence between the task and the document may be stored, so that when the task is executed again, new collected content is updated to the stored document. In this way, each time the task is executed, newly collected information may be added to the same document, which may help the user automatically collect and sort out information in the long term. Certainly, a file library specified by the user may also be searched to select a document matching the task currently being executed.

When a new document is created, various types of documents may be determined to be created according to an indication of the user in the task, or various types of documents may be determined to be created based on the intention of the task. For example, if the target information of the task is a large amount of text, a text document may be established. If the target information of the task includes multiple fields and a number of the fields is greater than a specified value, a table document may be established. The task and a processing indication may be input to the model, and if the processing indication represents that a type of the created document is determined, the type of the document output by the model may be obtained, and the document is created based on the type of the document. Currently, a default document type supported by the agent may also be selected, for example, a document type provided by an application where the agent is located.

In step S206, the target information is written into the document corresponding to the task.

In the preceding embodiment, whether to write the collected information into a newly created document or update a created document with the collected information is determined based on the number of executions of the task. Therefore, the information may be efficiently written into the document corresponding to the task.

Particularly, for a periodic task, information content collected in each execution of the task is different, but the types are similar. Through the preceding solution, information collected multiple times may be sorted into the same document, which is convenient for the user to view and compare, and greatly improves the information processing efficiency of the user.

Certainly, the preceding manner of determining the target document based on the number of executions of the task is merely exemplary. Based on a requirement, a person skilled in the art may also use another manner, for example, search for a document matching the task as the target document and ask the user to confirm. If no matching document is found, a new document is automatically created.

When the information is written into the document, the information obtained by the agent may be written into the document in sequence according to the time sequence of obtaining. Alternatively, in the case that the structure of the document is relatively complex, for example, the document includes a plurality of pages and a plurality of forms, the writing position may be automatically determined. An embodiment of the information writing method of the present disclosure is described below with reference to FIG. 3.

FIG. 3 is a schematic flowchart of an information writing method according to some other embodiments of the present disclosure. As shown in FIG. 3, the information writing method in this embodiment includes steps S302 to S306.

In step S302, one or more modules of a created document are determined according to content of the created document.

The module may be a structural unit in the document, such as a page or a sheet. Alternatively, the module may be divided according to semantics of the text, such as a chapter or a paragraph of the text.

When the one or more modules of the document are determined, semantic analysis may also be performed on content of each module to determine a module division manner. For example, the modules are divided by the time of information collection or by the category of the information.

In step S304, a target module corresponding to the target information is determined in the created document, the target module coming from the one or more modules or being a newly created module.

If the modules existing in the document are divided by the time of collection, a new module may be created as the target module, and the information collected in this execution of the task is written into the newly created module.

If the modules existing in the document are divided by the type of the information, the information collected in this execution of the task may be classified and added to the modules corresponding to the types respectively.

In step S306, the target information is written into the target module.

The preceding embodiment may implement automatic update of the document on the basis of implementing automatic information collection, so that the information collected in this execution of the task may be reasonably merged with the content already existing in the document, which reduces the subsequent editing cost of the user and improves the intelligence of automatic text generation.

The agent may provide the document to the user in a plurality of manners. In some embodiments, displaying the document provided by the agent to the user includes: displaying, in a conversation interface between the agent and the user, the document sent from the agent to the user. In this way, the agent may promptly notify the user of the completion of the task through the conversation interface. Alternatively, displaying the document provided by the agent to the user includes: displaying content of the document in a document editing interface associated with the agent, to facilitate the user to further send an editing instruction to the agent, so that the agent may assist the user in further editing the generated document, thereby improving the document processing efficiency.

With the method in each of the preceding embodiments, the user may implement automatic update of an article under a user account. For example, if the user account regularly publishes the latest progress in a specific field, the preceding manner may be used to regularly collect information in the field and automatically update or create the document under the user account, which may help the user improve the efficiency of content publication.

An exemplary embodiment of automatically performing an operation based on the platform interface image is further described below.

FIG. 4 is a schematic flowchart of an operation execution method according to some embodiments of the present disclosure. As shown in FIG. 4, the operation execution method in this embodiment includes steps S402 to S408.

In step S402, an image of a current interface of the platform is recognized.

A result of the image recognition includes, for example, recognition of text in the image, and may also include description information of a picture included in the image.

In step S404, whether the recognition result of the image of the current interface includes target information is determined according to the task requirement.

The task requirement includes a description of the target information to be obtained, such as "AI-related products", "products of company C", and "new breakthroughs in the medical field". By matching the task requirement with the recognition result, whether the current interface includes the target information may be determined.

In some embodiments, the recognition result and the task requirement may also be input to a model, so that the model outputs the target information that meets the task requirement in the recognition result.

In step S406, the target information is obtained from the current interface in response to the recognition result including the target information.

The text may be obtained through the copy operation, and the image may be obtained through the copy operation or the screenshot operation. Certainly, the interface may also include other types of target information, and the obtaining manners are not described herein one by one.

In some embodiments, a position of the target information in the current interface is determined in response to the recognition result including the target information; and the target information is obtained from the current interface according to the position. For example, after the target information is determined based on the result of the image recognition, the position of the target information in the image may be determined, and then the position of the target information in the current interface may be determined. When the target information is obtained, the movement of the simulated input device such as the simulated mouse may be triggered, and in response to the simulated input device moving to the position, the information acquisition operations such as the copy operation and the screenshot operation are triggered.

In step S408, an interaction operation is performed in the current interface to switch to another interface.

Step S408 may be performed regardless of whether the recognition result of the current interface includes the target information. That is, regardless of whether the target information is obtained from the current interface, the interaction operations such as triggering a new page, scrolling or zooming the current interface to display another position of the same page, and closing the current interface may be performed, to obtain more information from another page or another part of the current page.

That is, in some embodiments, the interaction operation is performed in the current interface to switch to the another interface in response to the recognition result not including the target information.

Several implementations of switching to the another interface are exemplarily described below.

In some embodiments, a first object in the current interface is determined according to the result of the image recognition of the current interface and the task requirement, the first object being associated with the task; and the first object is triggered in the current interface to switch to the another interface. The first object being associated with the task means that the first object and the task have similar themes or semantics, but the first object does not necessarily meet the task requirement. For example, the task requirement is to collect product introductions and release times of AI-related products, but the current interface only includes a list of names of AI-related products, which does not include the product introductions and the release times. Then, in the case that each object in the list is triggerable (that is, includes a jump link), the first object may be triggered to switch to a new interface, and the new interface may include more detailed introductions to the AI-related products.

Certainly, if there is no first object in untriggered objects in the current interface, another object, for example, a second object, such as a control used to trigger page turning or a pop-up window, may be triggered to switch to the another interface.

In some embodiments, a displacement operation is performed in the current interface to switch from the current interface to the another interface located on the same page or a different page. Due to a limitation in window size, the current interface may not display the entire page. Therefore, by automatically performing the displacement operation, the information on the current page may be more comprehensively obtained.

The preceding two exemplary methods may also be superimposed. For example, the plurality of images that may completely cover all the content on the current page may be preferentially obtained through the displacement operation. Each of these images at least has an overlapping area with another image, and these images include all cases where a scroll bar of the page is at an endpoint, to ensure that all the content on the page has been read. Then, the first object on the page is triggered to access a page at a next level of the current page.

After step S408 is completed, the method may return to step S402. That is, the "another interface" that is switched to becomes the "current interface", so that the operation in this embodiment may be continuously performed.

According to the preceding embodiment, the images of the plurality of interfaces in the platform may be cyclically obtained, so that the agent may automatically obtain the content in the platform, and the obtained information is more comprehensive. Moreover, the content in the interface may be accurately determined based on the image, and the operation position of the agent may be instructed. Therefore, in this way, the image processing and semantic understanding capabilities of the agent may be effectively used to help the user automatically collect the information, and the efficiency of automatic information collection is improved.

In some embodiments, the platform is a website, and performing the operation according to the image of the interface of the platform and the task requirement includes: loading, in response to starting the task, the website in a new tab page of a browser; and performing the operation based on an image of an interface of the tab page and the task requirement. Therefore, the web page being browsed by the user is prevented from being used as the operation object of the agent, and the user experience is improved.

The platform and the operation on the platform may be displayed in the software where the agent is located. In some embodiments, an interaction interface between the user and the agent is displayed, the interaction interface including a conversation area and an operation area, where the conversation area is used to display a conversation between the agent and the user; and the interface of the platform and an operation result of the interface are displayed in the operation area. That is, the conversation area and the operation area may be displayed on the same screen, for example, in a split screen manner. Therefore, while the agent automatically performs the operation, the user may send a message to the agent based on a requirement to control or adjust the task being executed, or the user may receive a feedback from the agent during the operation to promptly solve a problem arising during the automatic operation of the agent. Certainly, the user may also send the task to the agent through the conversation interface.

The agent may further record the process of automatically collecting the information. The record may be in the form of an image, text, or both. For example, in response to each operation being completed, at least one of description information of the operation or an image of an interface corresponding to the operation is generated; and at least one of the description information of each operation or the image of the interface corresponding to the operation is displayed. The description information of the operation is, for example, "copy xx information", "copy xx screenshot", and "click to jump to the next page". The image of the interface corresponding to the operation may be an image of the interface in the process of performing the operation or an image of the interface after the operation is completed. The description information of these operations and the image of the interface corresponding to the operations may be displayed to the user after each operation of the agent is completed, so as to interpret the operation of the agent in real time. Alternatively, the records corresponding to all the operations may be displayed in a centralized manner after the task is completed. In addition, the records may also be displayed in response to a request from the user. Therefore, the user may trace the operation process of the agent to determine the rationality of the collected information, thereby improving the reliability of the generated document.

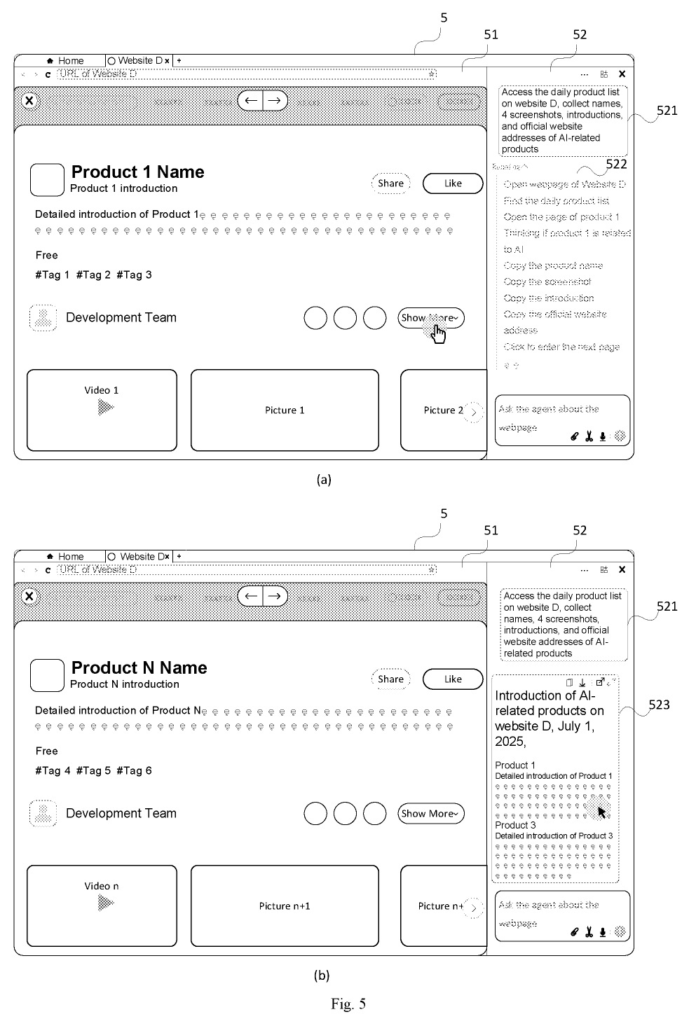

FIG. 5 is a schematic diagram of an interaction interface of an agent. In this embodiment, the operation performed by the agent is displayed to the user in real time in a browser. As shown in (a) of FIG. 5, a browser interface 5 embedded with an agent function includes an operation area 51 and a conversation area 52. Exemplarily, the operation area is on the left side of the interface 5, and the conversation area 52 is on the right side of the interface 5. The user sends a message 521 in the conversation area 52 to instruct the agent to complete the task of "accessing a daily product list on website D and collecting names, 4 screenshots, introductions, and official website addresses of AI-related products". After obtaining the task, the agent automatically loads website D in the operation area 51 and automatically performs the operation according to the task requirement of the user. The operation result may be synchronized to the user through the operation area 51 in real time. In the conversation area 52, the agent records an operation process 522, for example, including "open a web page of website D", "find the daily product list", "open a page of product 1", "consider whether product 1 is related to AI", "copy a product name", "copy a screenshot", "copy an introduction", "copy an official website", "click to enter the next page", etc.

After the agent completes the operation, for the interface 5, reference may be made to (b) for example. In (b), the agent has completed the task and sent a generated document 523 to the user, where the document includes the information automatically collected by the agent according to the task sent from the user. The user may further view the content of the document by triggering the document 523.

The embodiments of the present disclosure may be executed on a cloud or locally on the user device.

Executing locally on the user device has the advantage that when some data locally stored by the user is required during the operation, the security may be improved and data leakage may be avoided. For example, the browser of the user may store passwords of some websites, and if the operation is performed on the local browser of the user, the agent may complete the login process without obtaining content of the passwords.

Executing on the cloud has the advantage that no local resources of the user are occupied, and for some tasks that need to be performed multiple times, the user does not need to frequently turn on the user device. If the user needs, a real-time operation on the cloud may be transmitted back to the user device, so that the user may observe the operation process of the agent when necessary.

When the agent automatically runs, a special identification may be used. For example, an operation window is framed in a specified color to prompt the user that the agent is currently performing the operation.

The agent may also encounter some obstacles during the automatic execution process. For example, still taking the user login as an example, the operating environment of the platform may not store the password of the user, and the user needs to manually input the password. When encountering such a problem that the agent cannot continue to execute, the control over the platform may be transferred from the agent to the user, so that the user may complete the operation.

In some embodiments, in response to an inability to perform a first operation among the operations, first information sent from the agent to the user is displayed, the first information being for requesting the user to take over control of the platform; and during the user taking over the control, prompt information of the user taking over the control is displayed in the interface of the platform; and an instruction from the user to stop taking over is received to continue performing the operation according to the image of the interface of the platform and the task requirement.

The first information sent from the agent may be sent through the conversation interface, or may be sent through a pop-up window or the like. After the user confirms to take over the control of the platform, the agent may suspend the process of automatically executing the task. Then, the user manually performs the operation, for example, inputs the password and logs in. When the user considers that taking over has been completed, the agent may be triggered to automatically perform the subsequent operation by triggering a control, sending a message, etc. In this way, the user may be promptly informed in the case that the task cannot be automatically executed, so that the user may assist in solving the existing problem. Therefore, this manner of mixed operation by the agent and the user may improve the success rate of task execution.

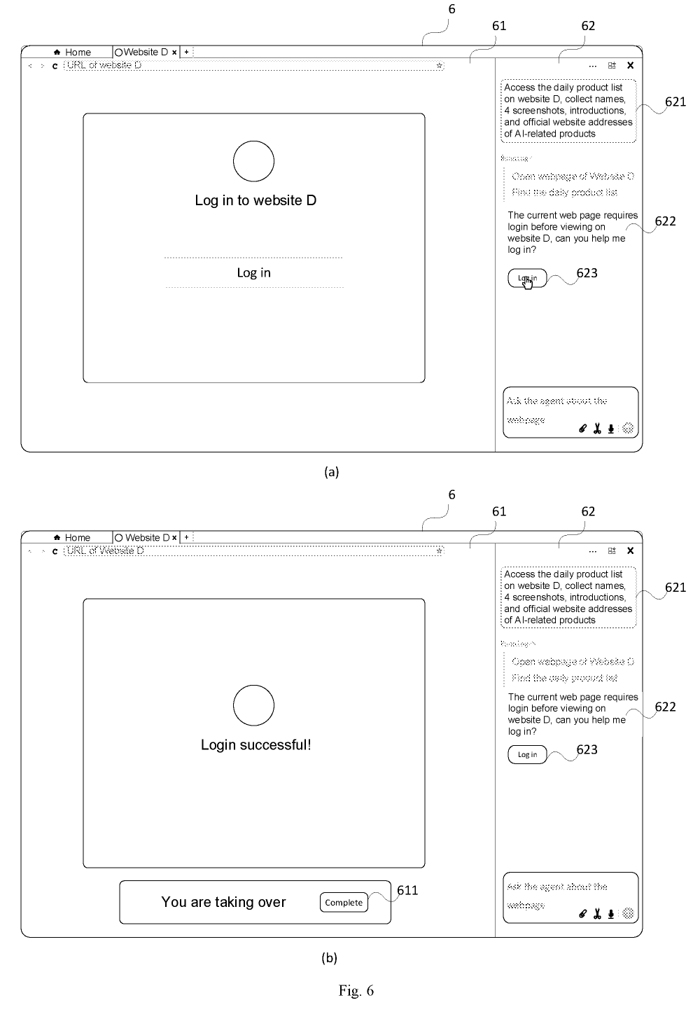

FIG. 6 is another schematic diagram of an interaction interface of an agent. In this embodiment, the operation performed by the agent is displayed to the user in real time in a browser. As shown in (a) of FIG. 6, a browser interface 6 embedded with an agent function includes an operation area 61 and a conversation area 62. The user sends a message 621 to publish a task to the agent. The agent encounters a problem that it cannot log in during the automatic execution process, and therefore sends a message 622 "the current web page requires login before viewing, can you help me log in?" to the user in the conversation area 62, and displays a control 623 "log in to the web page" to prompt the user to take over. In response to the user triggering the control 623, the control over the platform is transferred to the user, and the agent pauses executing the task. The user inputs login information on the web page in the operation area 61. The interface may be as shown in (b) of FIG. 6. After completing the login operation, the user may trigger a stop taking over control 611 in the operation area 61, so that the agent may continue to execute the task.

When publishing the task, the user may also use other manners in addition to the preceding manner of publishing through the conversation interface. For example, the agent may provide a floating window or a quick access entry control on the desktop, and after the control is triggered, an input box may be displayed or a voice receiving function may be enabled to obtain the task input by the user.

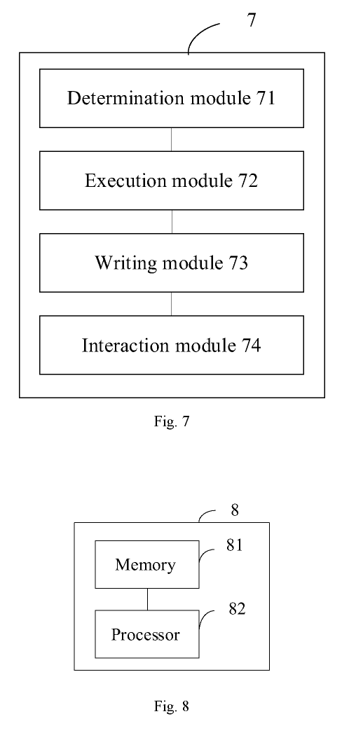

FIG. 7 is a schematic diagram of a structure of an automatic information collection apparatus according to some embodiments of the present disclosure. As shown in FIG. 7, the automatic information collection apparatus 7 in this embodiment includes: a determination module 71 configured to determine, according to a task sent from a user to an agent, a platform corresponding to the task and a task requirement; an execution module 72 configured to perform operations according to an image of an interface and the task requirement, the interface corresponding to the platform, and the operations including an interaction operation with the platform and an operation of obtaining target information from the platform; a writing module 73 configured to write the target information into a document; and an interaction module 74 configured to display the document to the user, the document being provided by the agent.

In the present disclosure, the agent processes the image of the interface of the platform corresponding to the task to determine a next operation of the agent, so that the target information may be identified and obtained from the platform and written into the document. Therefore, the user may obtain the information document automatically collected by the agent by sending the task to the agent, which reduces the threshold for automatic information collection and improves the efficiency of information collection.

In some embodiments, the document is a document corresponding to the task, and the writing module 73 is further configured to: determine a number of executions of the task according to an intention of the task; determine the document corresponding to the task according to the number of executions of the task; and write the target information into the document corresponding to the task.

In some embodiments, the writing module 73 is further configured to: determine, in response to the task having been executed at least once, a created document associated with the task as the document corresponding to the task; and determine, in response to the task being executed for the first time, a newly created document as the document corresponding to the task.

In some embodiments, the writing module 73 is further configured to: determine one or more modules of the created document according to content of the created document; determine, in the created document, a target module corresponding to the target information, the target module coming from the one or more modules or being a newly created module; and write the target information into the target module.

In some embodiments, the execution module 72 is further configured to: recognize an image of a current interface of the platform; determine, according to the task requirement, whether a recognition result of the image of the current interface includes the target information or not; obtain the target information from the current interface in response to the recognition result including the target information; and perform an interaction operation in the current interface to switch to another interface.

In some embodiments, the execution module 72 is further configured to: perform the interaction operation in the current interface to switch to the another interface in response to the recognition result not including the target information.

In some embodiments, the execution module 72 is further configured to: determine a position of the target information in the current interface in response to the recognition result including the target information; and obtain the target information from the current interface according to the position.

In some embodiments, the interaction operation includes a trigger operation, and the execution module 72 is further configured to: determine a first object in the current interface according to the recognition result of the image of the current interface and the task requirement, the first object being associated with the task; and trigger the first object in the current interface to switch to the another interface.

In some embodiments, the interaction operation includes a displacement operation, and the execution module 72 is further configured to: perform the displacement operation in the current interface to switch from the current interface to the another interface, the current interface and the another interface locating on a same page or a different page.

In some embodiments, the platform is a website, and the execution module 72 is further configured to: load, in response to starting the task, the website in a new tab page of a browser; and perform the operations based on an image of an interface of the tab page and the task requirement.

In some embodiments, the interaction module 74 is further configured to: display, in a conversation interface between the agent and the user, the document sent from the agent to the user; or display content of the document in a document editing interface associated with the agent.

In some embodiments, the interaction module 74 is further configured to: generate, in response to each of the operations being completed, at least one of description information of the operation or an image of an interface corresponding to the operation; and display at least one of the description information of the each operation or the image of the interface corresponding to the operation.

In some embodiments, the interaction module 74 is further configured to: display, in response to an inability to perform a first operation among the operations, first information sent from the agent to the user, the first information being for requesting the user to take over control of the platform; and display, during the user taking over the control, prompt information of the user taking over the control in the interface of the platform; and receive an instruction from the user to stop taking over to continue performing the operations according to the image of the interface of the platform and the task requirement.

In some embodiments, the interaction module 74 is further configured to: display an interaction interface between the user and the agent, the interaction interface including a conversation area and an operation area, the conversation area being for displaying a conversation between the agent and the user; and display, in the operation area, the interface of the platform and an operation result of the interface.

FIG. 8 is a block diagram of an electronic device according to some embodiments of the present disclosure.

A memory 81 is used to store one or more computer-readable instructions. The memory 81 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 81 may store, for example, an operating system, an application, a boot loader, a database, and other programs, and may also store various applications, various data, etc.

A processor 82 is used to run the computer-readable instructions to implement the method according to any one of the preceding embodiments. For the specific implementation of each step of the method, reference may be made to the preceding embodiments, and details of the same parts are not repeated herein.

The processor 82 may be configured to perform each step of each of the preceding embodiments. The processor 82 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may have an X86 or ARM architecture or the like.

The processor 82 and the memory 81 may directly or indirectly communicate with each other. For example, the processor 82 and the memory 81 may communicate through a network. The network may include a wireless network, a wired network, and/or any combination of a wireless network and a wired network. The processor 82 and the memory 81 may also communicate with each other through a system bus, which is not limited in the present disclosure.

It should be noted that the components of the electronic device 8 shown in FIG. 8 are merely exemplary and non-limiting, and the electronic device 8 may have other components according to actual application requirements. The processor 82 may control other components in the electronic device 8 to perform desired functions.

The electronic device 8 may be implemented by software, firmware, and/or hardware, and may be integrated into an apparatus installed with the relevant application.

By using the electronic device to perform the method according to any one of the embodiments of the present disclosure, the agent processes the image of the interface of the platform corresponding to the task to determine the next operation of the agent, so that the target information may be identified and obtained from the platform and written into the document. Therefore, the user may obtain the information document automatically collected by the agent by sending the task to the agent, which reduces the threshold for automatic information collection and improves the efficiency of information collection.

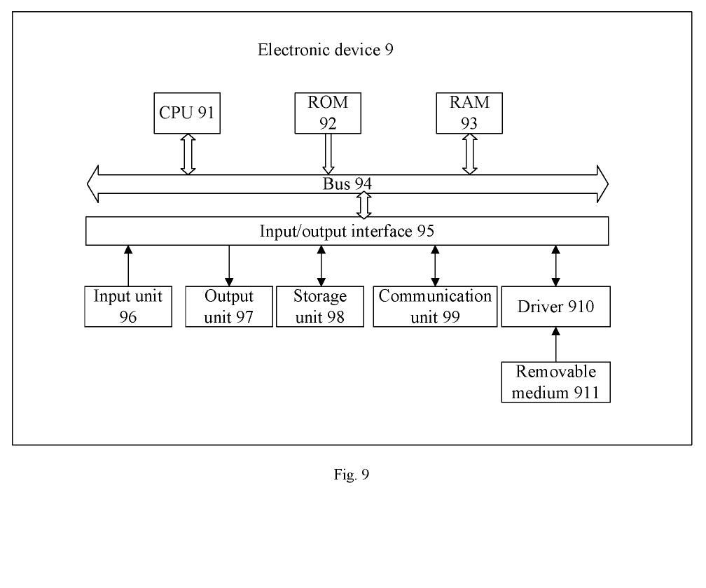

FIG. 9 is a block diagram of an electronic device according to some other embodiments of the present disclosure.

The electronic device 9 shown in FIG. 9 may be a computer system having a dedicated hardware structure, and may perform corresponding functions when the relevant application is installed thereon.

The electronic device includes, but is not limited to, a mobile terminal such as a smartphone, a notebook computer, a personal digital assistant (abbreviated as PDA), a tablet personal computer (abbreviated as Tablet PC), a portable multimedia player (abbreviated as PMP), a vehicle-mounted terminal (such as a vehicle navigation terminal), and a wearable device, and a fixed terminal such as a digital TV and a desktop computer.

As shown in FIG. 9, a central processing unit (abbreviated as CPU) 91 performs various processes based on a program stored in a read-only memory (abbreviated as ROM) 92 or a program loaded from a storage unit 98 into a random access memory (abbreviated as RAM) 93. The RAM 93 stores data required when the CPU 91 performs the various processes, etc., as needed. The central processing unit is merely exemplary, and it may be other types of processors, such as the various processors described above. The ROM 92, the RAM 93, and the storage unit 98 may be various forms of computer-readable storage media. It should be noted that although the ROM 92, the RAM 93, and the storage unit 98 are shown separately in FIG. 9, one or more of them may be combined or located in the same or different memories or storage modules.

The CPU 91, the ROM 92, and the RAM 93 are connected to each other via a bus 94. An input/output interface 95 is also connected to the bus 94.

The input/output interface 95 is connected to: an input unit 96 such as a touch screen, a touchpad, a keyboard, a mouse, an image sensor, a microphone, an accelerometer, and a gyroscope; an output unit 97 including a display, such as a cathode ray tube (CRT), a liquid crystal display (LCD), a speaker, and a vibrator; the storage unit 98 including a hard disk and a magnetic tape; and a communication unit 99 including a network interface card such as a LAN card and a modem. The communication unit 99 allows communication processing to be performed via a network such as the Internet. It is easy to understand that although the components in the electronic device 9 shown in FIG. 9 communicate through the bus 94, they may also communicate through a network or other means, where the network may include a wireless network, a wired network, and/or any combination of a wireless network and a wired network.

A driver 910 is also connected to the input/output interface 95 as needed. A removable medium 911 such as a magnetic disk, an optical disc, a magneto-optical disc, and a semiconductor memory is mounted on the driver 910 as needed, so that a computer program read therefrom is installed into the storage unit 98 as needed.

In the case where the preceding series of processes are implemented by software, a program constituting the software may be installed from a network such as the Internet or a storage medium such as the removable medium 911.

According to the embodiments of the present disclosure, the process described above with reference to the flowchart may be implemented as a computer software program. For example, some embodiments of the present disclosure include a computer program product that, when running on a computer, causes the computer to implement the method according to any one of the preceding embodiments. The computer program product includes computer instructions carried on a computer-readable medium and includes program code for performing the method shown in the flowchart. In such an embodiment, the computer instructions may be downloaded and installed from a network through the communication unit 99, or installed from the storage unit 98, or installed from the ROM 92. When the computer program is executed by the CPU 91, the method according to the embodiments of the present disclosure is executed.

It should be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination of the two.

The computer-readable storage medium includes, but is not limited to, an electrical, magnetic, optical, electromagnetic, infrared, or semiconductor system, apparatus, or device, or any combination of the preceding. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the preceding. In the present disclosure, the computer-readable storage medium may be any tangible medium that includes or stores a program, and the program may be used by or in combination with an instruction execution system, apparatus, or device. The computer-readable storage medium stores computer instructions that, when executed by the processor, implement the method according to any one of the preceding embodiments.

The computer-readable signal medium may include a data signal propagated on a baseband or as a part of a carrier, and computer-readable program code is carried therein. The data signal propagated in this manner may be in multiple forms, and includes, but is not limited to, an electromagnetic signal, an optical signal, or any suitable combination of the preceding. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to: a wire, an optical cable, a radio frequency (RF), etc., or any suitable combination of the preceding.

The preceding computer-readable medium may be included in the electronic device or may exist alone without being assembled into the electronic device.

By using the computer-readable medium to perform the method according to any one of the embodiments of the present disclosure, the agent processes the image of the interface of the platform corresponding to the task to determine the next operation of the agent, so that the target information may be identified and obtained from the platform and written into the document. Therefore, the user may obtain the information document automatically collected by the agent by sending the task to the agent, which reduces the threshold for automatic information collection and improves the efficiency of information collection.

In some embodiments, there is further provided a computer program, including: instructions that, when executed by a processor, cause the processor to perform the method according to any one of the preceding embodiments. For example, the instructions may be embodied as computer program code.

In the embodiments of the present disclosure, the computer program code for performing the operations of the present disclosure may be written in one or more programming languages or a combination thereof, where the preceding programming languages include but are not limited to object-oriented programming languages, such as Java, Smalltalk, and C++, and further include conventional procedural programming languages, such as "C" language or similar programming languages. The program code may be completely executed on a user computer, partially executed on a user computer, executed as an independent software package, partially executed on a user computer and partially executed on a remote computer, or completely executed on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).)

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The functions described above may be performed at least partially by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Some embodiments of the present disclosure provide an automatic collection method of information, including: determining, according to a task sent from a user to an agent, a platform corresponding to the task and a task requirement; performing operations according to an image of an interface and the task requirement, the interface corresponding to the platform, and the operations including an interaction operation with the platform and an operation of obtaining target information from the platform; writing the target information into a document; and displaying the document to the user, the document being provided by the agent.

In some embodiments, the document is a document corresponding to the task, and writing the target information into the document includes: determining a number of executions of the task according to an intention of the task; determining the document corresponding to the task according to the number of executions of the task; and writing the target information into the document corresponding to the task.

In some embodiments, determining the document corresponding to the task according to the number of executions of the task includes: determining, in response to the task having been executed at least once, a created document associated with the task as the document corresponding to the task; and determining, in response to the task being executed for the first time, a newly created document as the document corresponding to the task.

In some embodiments, the document is the created document, and writing the target information into the document includes: determining one or more modules of the created document according to content of the created document; determining, in the created document, a target module corresponding to the target information, the target module coming from the one or more modules or being a newly created module; and writing the target information into the target module.

In some embodiments, performing the operation according to the image of the interface of the platform and the task requirement includes: recognizing an image of a current interface of the platform; determining, according to the task requirement, whether a recognition result of the image of the current interface includes the target information or not; obtaining the target information from the current interface in response to the recognition result including the target information; and performing an interaction operation in the current interface to switch to another interface.

In some embodiments, performing the operations according to the image of the interface of the platform and the task requirement further includes: performing the interaction operation in the current interface to switch to the another interface in response to the recognition result not including the target information.

In some embodiments, obtaining the target information from the current interface in response to the recognition result including the target information includes: determining a position of the target information in the current interface in response to the recognition result including the target information; and obtaining the target information from the current interface according to the position.

In some embodiments, the interaction operation includes a trigger operation, and performing the interaction operation in the current interface to switch to the another interface includes: determining a first object in the current interface according to the recognition result of the image of the current interface and the task requirement, the first object being associated with the task; and triggering the first object in the current interface to switch to the another interface.

In some embodiments, the interaction operation includes a displacement operation, and performing the interaction operation in the current interface to switch to the another interface includes: performing the displacement operation in the current interface to switch from the current interface to the another interface, the current interface and the another interface locating on a same page or a different page.

In some embodiments, the platform is a website, and performing the operations according to the image of the interface of the platform and the task requirement includes: loading, in response to starting the task, the website in a new tab page of a browser; and performing the operations based on an image of an interface of the tab page and the task requirement.

In some embodiments, displaying the document provided by the agent to the user includes: displaying, in a conversation interface between the agent and the user, the document sent from the agent to the user; or displaying content of the document in a document editing interface associated with the agent.

In some embodiments, the automatic collection method further includes: generating, in response to each of the operations being completed, at least one of description information of the operation or an image of an interface corresponding to the operation; and displaying at least one of the description information of the each operation or the image of the interface corresponding to the operation.

In some embodiments, the automatic collection method further includes: displaying, in response to an inability to perform a first operation among the operations, first information sent from the agent to the user, the first information being for requesting the user to take over control of the platform; and displaying, during the user taking over the control, prompt information of the user taking over the control in the interface of the platform; and receiving an instruction from the user to stop taking over to continue performing the operations according to the image of the interface of the platform and the task requirement.

In some embodiments, the automatic collection method further includes: displaying an interaction interface between the user and the agent, the interaction interface including a conversation area and an operation area, the conversation area being for displaying a conversation between the agent and the user; and displaying, in the operation area, the interface of the platform and an operation result of the interface.

Some embodiments of the present disclosure provide an automatic information collection apparatus, including: a determination module configured to determine, according to a task sent from a user to an agent, a platform corresponding to the task and a task requirement; an execution module configured to perform operations according to an image of an interface and the task requirement, the interface corresponding to the platform, and the operations including an interaction operation with the platform and an operation of obtaining target information from the platform; a writing module configured to write the target information into a document; and an interaction module configured to display the document to the user, the document being provided by the agent.

Some embodiments of the present disclosure provide an electronic device, including: a memory; and a processor coupled to the memory, where the processor is configured to perform the automatic information collection method according to any one of the embodiments of the present disclosure based on instructions stored in the memory.

Some embodiments of the present disclosure provide a non-transitory computer-readable storage medium having a computer program stored thereon, where the program, when executed by a processor, implements the automatic information collection method according to any one of the embodiments of the present disclosure.

Some embodiments of the present disclosure provide a computer program product that, when running on a computer, causes the computer to implement the automatic information collection method according to any one of the embodiments of the present disclosure.

According to the preceding embodiments, the agent processes the image of the interface of the platform corresponding to the task to determine the next operation of the agent, so that the target information may be identified and obtained from the platform and written into the document. Therefore, the user may obtain the information document automatically collected by the agent by sending the task to the agent, which reduces the threshold for automatic information collection and improves the efficiency of information collection.

Although some specific embodiments of the present disclosure have been described in detail by way of examples, those skilled in the art should understand that the preceding examples are only for illustration, rather than limiting the scope of the present disclosure. Those skilled in the art should understand that the preceding embodiments may be modified without departing from the scope and spirit of the present disclosure. The scope of the present disclosure is defined by the appended claims.

1. An automatic collection method of information, comprising:
determining, according to a task sent from a user to an agent, a platform corresponding to the task and a task requirement;
performing operations according to an image of an interface and the task requirement, the interface corresponding to the platform, and the operations comprising an interaction operation with the platform and an operation of obtaining target information from the platform;
writing the target information into a document; and
displaying the document to the user, the document being provided by the agent.

2. The automatic collection method of claim 1, wherein the document is a document corresponding to the task, and writing the target information into the document comprises:
determining a number of executions of the task according to an intention of the task;
determining the document corresponding to the task according to the number of executions of the task; and
writing the target information into the document corresponding to the task.

3. The automatic collection method of claim 2, wherein determining the document corresponding to the task according to the number of executions of the task comprises:
determining, in response to the task having been executed at least once, a created document associated with the task as the document corresponding to the task; and
determining, in response to the task being executed for the first time, a newly created document as the document corresponding to the task.

4. The automatic collection method of claim 1, wherein the document is a created document, and writing the target information into the document comprises:
determining one or more modules of the created document according to content of the created document;
determining, in the created document, a target module corresponding to the target information, the target module coming from the one or more modules or being a newly created module; and
writing the target information into the target module.

5. The automatic collection method of claim 1, wherein performing the operations according to the image of the interface of the platform and the task requirement comprises:
recognizing an image of a current interface of the platform;
determining, according to the task requirement, whether a recognition result of the image of the current interface comprises the target information or not;
obtaining the target information from the current interface in response to the recognition result comprising the target information; and
performing the interaction operation in the current interface to switch to another interface.

6. The automatic collection method of claim 5, wherein performing the operations according to the image of the interface of the platform and the task requirement further comprises:
performing the interaction operation in the current interface to switch to the another interface in response to the recognition result not comprising the target information.

7. The automatic collection method of claim 5, wherein obtaining the target information from the current interface in response to the recognition result comprising the target information comprises:
determining a position of the target information in the current interface in response to the recognition result comprising the target information; and
obtaining the target information from the current interface according to the position.

8. The automatic collection method of claim 5, wherein the interaction operation comprises a trigger operation, and performing the interaction operation in the current interface to switch to the another interface comprises:
determining a first object in the current interface according to the recognition result of the image of the current interface and the task requirement, the first object being associated with the task; and
triggering the first object in the current interface to switch to the another interface.

9. The automatic collection method of claim 5, wherein the interaction operation comprises a displacement operation, and performing the interaction operation in the current interface to switch to the another interface comprises:
performing the displacement operation in the current interface to switch from the current interface to the another interface, the current interface and the another interface locating on a same page or a different page.

10. The automatic collection method of claim 1, wherein the platform is a website, and performing the operations according to the image of the interface of the platform and the task requirement comprises:
loading, in response to starting the task, the website in a new tab page of a browser; and
performing the operations based on an image of an interface of the tab page and the task requirement.

11. The automatic collection method of claim 1, wherein displaying the document provided by the agent to the user comprises:
displaying, in a conversation interface between the agent and the user, the document sent from the agent to the user; or
displaying content of the document in a document editing interface associated with the agent.

12. The automatic collection method of claim 1, further comprising:
generating, in response to each of the operations being completed, at least one of description information of the operation or an image of an interface corresponding to the operation; and
displaying at least one of the description information of the each operation or the image of the interface corresponding to the operation.

13. The automatic collection method of claim 1, further comprising:
displaying, in response to an inability to perform a first operation among the operations, first information sent from the agent to a user, the first information being for requesting the user to take over control of the platform;
displaying, during the user taking over the control, prompt information of the user taking over the control in the interface of the platform; and
receiving an instruction from the user to stop taking over to continue performing the operations according to the image of the interface of the platform and the task requirement.

14. The automatic collection method of claim 1, further comprising:
displaying an interaction interface between the user and the agent, the interaction interface comprising a conversation area and an operation area, the conversation area being for displaying a conversation between the agent and the user; and
displaying, in the operation area, the interface of the platform and an operation result of the interface.

15. An electronic device, comprising:
at least one memory; and
at least one processor coupled to the at least one memory, the at least one processor being configured to, based on instructions stored in the memory, perform an automatic collection method of information comprising:
determining, according to a task sent from a user to an agent, a platform corresponding to the task and a task requirement;
performing operations according to an image of an interface and the task requirement, the interface corresponding to the platform, and the operations comprising an interaction operation with the platform and an operation of obtaining target information from the platform;
writing the target information into a document; and
displaying the document to the user, the document being provided by the agent.

16. The electronic device according to claim 15, wherein the document is a document corresponding to the task, and writing the target information into the document comprises:
determining a number of executions of the task according to an intention of the task;
determining the document corresponding to the task according to the number of executions of the task; and
writing the target information into the document corresponding to the task.

17. The electronic device according to claim 16, wherein determining the document corresponding to the task according to the number of executions of the task comprises:
determining, in response to the task having been executed at least once, a created document associated with the task as the document corresponding to the task; and
determining, in response to the task being executed for the first time, a newly created document as the document corresponding to the task.

18. The electronic device according to claim 15, wherein the document is a created document, and writing the target information into the document comprises:
determining one or more modules of the created document according to content of the created document;
determining, in the created document, a target module corresponding to the target information, the target module coming from the one or more modules or being a newly created module; and
writing the target information into the target module.

19. The electronic device according to claim 15, wherein performing the operations according to the image of the interface of the platform and the task requirement comprises:
recognizing an image of a current interface of the platform;
determining, according to the task requirement, whether a recognition result of the image of the current interface comprises the target information or not;
obtaining the target information from the current interface in response to the recognition result comprising the target information; and
performing the interaction operation in the current interface to switch to another interface.

20. A non-transitory computer-readable storage medium having a computer program stored thereon, wherein the program, when executed by a processor, implements an automatic collection method of information comprising:
determining, according to a task sent from a user to an agent, a platform corresponding to the task and a task requirement;
performing operations according to an image of an interface and the task requirement, the interface corresponding to the platform, and the operations comprising an interaction operation with the platform and an operation of obtaining target information from the platform;
writing the target information into a document; and
displaying the document to the user, the document being provided by the agent.
